(19) United States
(12) Patent Application Publication
(10) Pub. No.: US 2016/0313668 A1
(43) Pub. Date: Oct. 27, 2016

(54) IMAGE FORMING APPARATUS

(71) Applicants: Tadashi KASAI, Kanagawa (JP); Makoto Yasuda, Kanagawa (JP); Mutsuki Morinaga, Kanagawa (JP); Hitoshi Yamamoto, Kanagawa (JP); Emiko Shiraishi, Tokyo (JP); Yuichi Aizawa, Ibaraki (JP); Takamasa Ozeki, Kanagawa (JP); Jun Hitosugi, Tokyo (JP); Kunio Hasegawa, Kanagawa (JP); Wakana Itoh, Kanagawa (JP); Takatsugu Komori, Chiba (JP)

(72) Inventors: Tadashi KASAI, Kanagawa (JP); Makoto Yasuda, Kanagawa (JP); Mutsuki Morinaga, Kanagawa (JP); Hitoshi Yamamoto, Kanagawa (JP); Emiko Shiraishi, Tokyo (JP); Yuichi Aizawa, Ibaraki (JP); Takamasa Ozeki, Kanagawa (JP); Jun Hitosugi, Tokyo (JP); Kunio Hasegawa, Kanagawa (JP); Wakana Itoh, Kanagawa (JP); Takatsugu Komori, Chiba (JP)

(21) Appl. No.: 15/202,024

(22) Filed: Jul. 5, 2016

Related U.S. Application Data
(63) Continuation of application No. PCT/JP2014/082303, filed on Dec. 5, 2014.

(30) Foreign Application Priority Data
Jan. 10, 2014 (JP) 2014-003288
Sep. 5, 2014 (JP) 2014-181092

(51) Int. Cl. G03G 15/08

(52) U.S. Cl. CPC G03G 15/0824

(57) ABSTRACT

In an image forming apparatus, provided with for each toner category a supply toner conveyance path including, at least as components, a developing means, a toner container corresponding to the developing means, and a connection means corresponding to the developing means and the toner container, each of the components of the supply toner conveyance path being individually replaceable, and includes a toner category detection means configured to detect toner category used in each component; a reporting means configured to report whether toner categories respectively used in all components of the same supply toner conveyance path are the same; and a control means configured to control the reporting means, based on detection information by the toner category detection means, when the component of the supply toner conveyance path is replaced.

### CROSS-REFERENCE TO RELATED APPLICATIONS

The present application is a continuation application of International Application No. PCT/JP2014/082303, filed Dec. 5, 2014, which claims priority to Japanese priority applications No. 2014-003288 filed on Jan. 10, 2014 and No. 2014-181092 filed on Sep. 5, 2014. The contents of these applications are incorporated herein by reference in their entirety.

### BACKGROUND OF THE INVENTION

1. Field of the Invention

The present invention relates to an image forming apparatus such as a copier, a printer, or a facsimile machine.

2. Description of the Related Art

Some recent image forming apparatuses can use special color toner in addition to process color toner of CMYK (cyan (C), magenta (M), yellow (Y) and black (K)).

The special color toner includes, for example, clear toner (transparent toner, colorless toner, achromatic toner, no pigment toner) or R (red) G (green) B (blue) toner.

An image forming apparatus, in which clear toner can be used, overlays the clear toner on whole or a part of a colored printed material to perform printing, and performs gloss control. Therefore, a printed material of high value can be generated.

An image forming apparatus, in which RGB toner can be used, can reproduce color with high quality that is hard to be reproduced by superposing process color toners of CMYK. There are a variety of special color toners other than these special color toners.

For the image forming apparatus, in which these special color toners can be used, a configuration having an image forming station for special color toner in addition to image forming stations for respective process color toners of CMYK has been known. By providing a plurality of image forming stations corresponding to a variety of special color toners, a printed material of high value can be generated.

However, because such an image forming apparatus requires addition of an image forming station correspondingly to special color toner to be used, a simple configuration cannot be provided and there is a problem that the apparatus cannot be downsized or a weight of the apparatus cannot be reduced.

Moreover, for the image forming apparatus, in which special color toners can be used, a configuration that is replaceable by an image forming station of different toner has been known (See, for example, Japanese Patent No. 4321583).

An image forming apparatus disclosed in Japanese Patent No. 4321583 has a configuration that an image forming station of process color toner and an image forming station of special color toner are replaceable, and thereby an order of overlaying the process color toner and the special color toner is controllable, and a printed material of high value can be generated.

Specifically, operations of replacing an image forming station of process color toner by an image forming station of special color toner, replacing an image forming station of special color toner for an image forming station of process color toner, replacing an image forming station of special color toner by another image forming station of special color toner, and replacing an image forming station of process color toner by another image forming station of process color toner are enabled.

However, in the image forming apparatus disclosed in Japanese Patent No. 4321583, on an operation of replacing different toners, color mixture (contamination, pollution, mixing or the like) that a user does not intend may occur. Therefore, there is a problem of occurrence of an anomalous image, breakage of the image forming station or the like. Moreover, the image forming apparatus disclosed in Japanese Patent No. 4321583 has a problem in handleability because of great size of an image forming station upon replacing each image forming station. Furthermore, because such an image forming apparatus requires a frame of high rigidity and has a great weight, there is a problem in operability in replacing.

In order to solve the above-described problems, an image forming apparatus that executes an operation of replacing different toners in a state that runs out of toner in developing agent has been known (See, for example, Japanese Unexamined Patent Application Publication No. 2010-66473).

However, for the image forming apparatus disclosed in Japanese Unexamined Patent Application Publication No. 2010-66473, reduction of waiting time during the replacement operation is required because the operation of replacing different toners is executed after ejecting toner in the developing agent and providing a state running out of toner.

### SUMMARY OF THE INVENTION

It is an object of one embodiment of the present invention to provide an image forming apparatus, which can be easily replaced by different toner, in which waste of toner is suppressed and color mixture of toner can be prevented.

In order to solve the above-described problem, an image forming apparatus recited in claim 1 of the present invention includes a plurality of developing means configured to use toners, toner categories of which are different from each other; a plurality of toner containers configured to store toners, toner categories of which are different from each other; a plurality of connection means configured to connect the respective plurality of toner containers with a corresponding one of the plurality of developing means, respectively. In the image forming apparatus provided with for each toner category a supply toner conveyance path including, at least as components, one of the plurality of developing means, one of the plurality of toner containers corresponding to the one of the plurality of developing means, and one of the plurality of connection means corresponding to the one of the plurality of developing means and the one of the plurality of toner containers, each of the components of the supply toner conveyance being able to be replaced individually, and includes a toner category detection means configured to detect toner category used in each component; a reporting means configured to report whether toner categories used respectively in all components of the same supply toner conveyance path are the same; and a control means configured to control the reporting means, based on detection information by the toner category detection means, when the component of the supply toner conveyance path is replaced.

### BRIEF DESCRIPTION OF THE DRAWINGS

Other objects and further features of embodiments will become apparent from the following detailed description when read in conjunction with the accompanying drawings, in which:

FIG. 1 is a configuration diagram depicting schematically an image forming apparatus according to an embodiment of the present invention;

FIG. 2 is a configuration diagram depicting schematically a control unit of the image forming apparatus illustrated in FIG. 1;

FIG. 3 is a configuration diagram depicting schematically a supply toner conveyance path of the image forming apparatus illustrated in FIG. 1;

FIG. 4 is an explanation diagram for explaining the supply toner conveyance path of the image forming apparatus illustrated in FIG. 1;

FIG. 5 is an explanation diagram for explaining an attachment/detachment state detection means and a toner category detection means of the image forming apparatus illustrated in FIG. 1;

FIG. 6 is an explanation diagram for explaining a start flow of an RFID tag that is attached to each member of a first toner conveyance path of the image forming apparatus illustrated in FIG. 1;

FIG. 7 is an explanation diagram for explaining replacement of the first toner conveyance path of the image forming apparatus illustrated in FIG. 1;

FIG. 8 is a flowchart for explaining replacement of a component of the first toner conveyance path of the image forming apparatus illustrated in FIG. 1;

FIG. 9 is a flowchart for explaining a recognition process for attachment/detachment of the component of the first toner conveyance path of the image forming apparatus illustrated in FIG. 1;

FIG. 10 is a flowchart for explaining a recognition process for toner category of the component of the first toner conveyance path of the image forming apparatus illustrated in FIG. 1;

FIGS. 11A to 11C are explanation diagrams for explaining a reporting means of the image forming apparatus illustrated in FIG. 1;

FIG. 12 is an explanation diagram for explaining replacement of a component of the first toner conveyance path of the image forming apparatus illustrated in FIG. 1;

FIG. 13 is a flowchart for explaining replacement of a component of the first toner conveyance path of the image forming apparatus illustrated in FIG. 1.

### DESCRIPTION OF THE PREFERRED EMBODIMENTS

Next, an embodiment of an image forming apparatus to which the present invention is applied will be described according to the drawings as follows. In each of the drawings for explaining the embodiment, the same reference numeral is assigned to components, such as members or configuration parts, having the same function or the same shape, and after once explaining, the explanation thereof will be arbitrarily omitted.

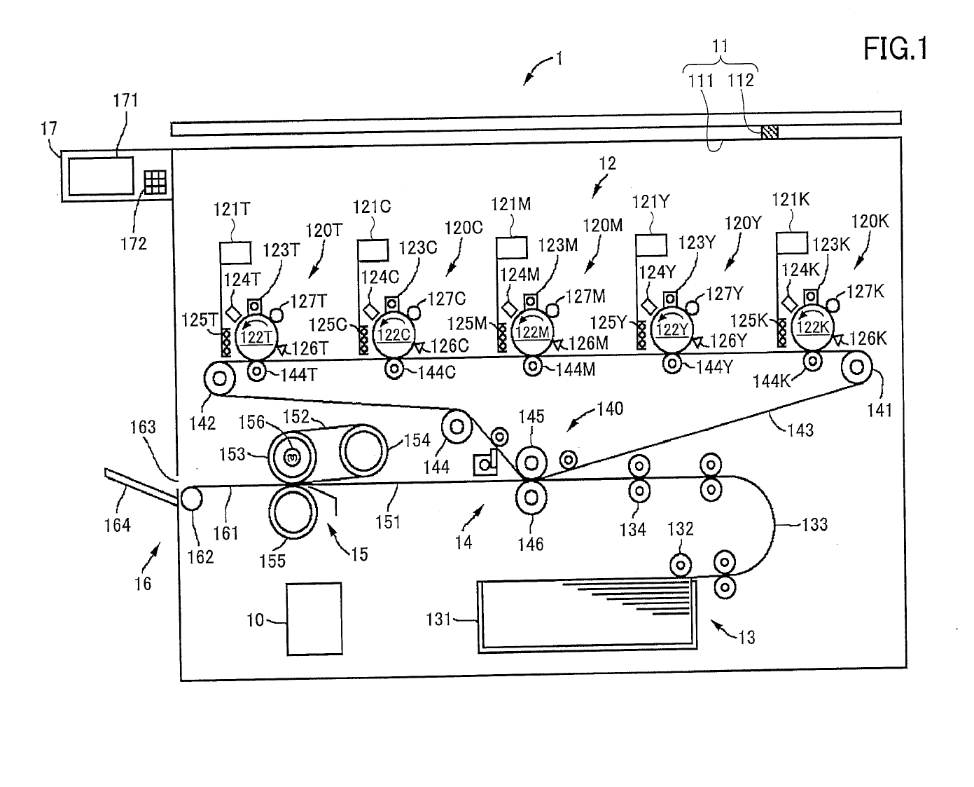

The image forming apparatus 1 according to the embodiment forms an image by fixing a toner image on a sheet of paper, as an example of a recording medium. The image forming apparatus 1 includes, as illustrated in FIG. 1, a control unit 10, an image readout unit 11, an image forming unit 12, a paper feed unit 13, a transfer unit 14, a fixing unit 15, a paper ejection unit 16, a display/operation unit 17 and the like.

The image readout unit 11 generates image information by optically reading out an image described on a sheet of paper. Specifically, the sheet of paper is irradiated with light, and reflected light is received by a readout sensor such as CCD (Charge Coupled Devices) or CIS (Contact Image Sensor), and thereby image information is read out. Image information is information representing an image that is formed on a recording medium, such as a sheet of paper, and indicated by using electric color separation image signals indicating respective colors of red (R), green (G) and blue (B).

The image readout unit 11, as illustrated in FIG. 1, includes a contact glass 111, a readout sensor 112 and the like. The contact glass 111 is a member on which a sheet of paper describing image is placed. The readout sensor 112 is a member which reads out image information of an image described on a sheet of paper that is placed on the contact glass 111.

The image forming unit 12 is a member that forms an image (toner image) by causing process color toner and special color toner to adhere to a surface of an intermediate transfer belt 143 of the transfer unit 14, based on the image information read out by the image readout unit 11 or image information received by a network I/F 102.

The image forming unit 12 is provided with image formation units 120C, 120M, 120Y, 120K and 120T for forming toner images of respective colors of cyan (C), magenta (M), yellow (Y), black (K) and clear (T).

Toner of color C, toner of color M, toner of color Y and toner of color K are referred to as process color toner, and toner of color T is referred to as special color toner.

The respective process color toners are resin particles provided with electrification including color material such as pigment or dye.

There are various kinds of special color toners, such as orange, violet, green, light black, fluorescence color, clear (transparent), white, black, or metallic (metal color). These toners enable various expressions by overlaying process color toner on a sheet of paper.

These image formation units have the same configuration, respectively, other than difference in toner. In the following description, indices of C, M Y, K, and T in reference numerals will be appropriately omitted for explanation.

The image formation unit 120 includes a toner bottle 121 as a toner container, a photoconductor drum 122 as an image bearer, a charging unit 123, an exposure unit 124, a developing unit 125 as a developing means, a discharging unit 126, a cleaning unit 127 and the like.

The toner bottle 121 stores toners of respective colors. Moreover, the toner bottle 121 can be stored in a toner bottle storage unit formed in an image forming apparatus main body. The toner stored in the toner bottle 121 is supplied to the developing unit 125 by a predetermined amount.

Toner bottles of process color toners, 121C, 121M, 121Y and 121K are coupled immediately above or above the developing units 125C, 125M, 125Y and 125K, respectively, via supply tubes 181C, 181M, 181Y and 181K. Then, toners fall from the toner bottles of the process color toners, 121C, 121M, 121Y and 121K, and thereby the toners are supplied to the developing units 125C, 125M, 125Y and 125K via the supply tubes 181C, 181M, 181Y and 181K. Therefore, the image forming apparatus can be downsized.

On the other hand, the toner bottle of the special color toner 121T is coupled to the developing unit 125T via a supply tube 181T as a connection means, a diaphragm pump 183T as a conveyance means, and a sub hopper 182T. Then, toner in the toner bottle of the special color toner 121T is supplied to the developing unit 125T by a pressure of the diaphragm pump 183T. Therefore, the toner bottle of the special color toner 121T is not affected by a position of the developing unit 125T and arranged at an arbitrary position.

For example, when the image forming apparatus 1 includes a scanner, the scanner is arranged in the uppermost part of the image forming apparatus 1, taking account of its usability. On a side of the scanner, the toner bottles of the process color toner 121C, 121M, 121Y and 121K are serially arranged in series, for downsizing the image forming apparatus 1. Then, in the embodiment, as illustrated in FIG. 4, the toner bottle of the special color toner 121T is arranged below the toner bottle 121K.

When the toner bottle of the special color toner 121T is arranged, for example, below the toner bottle 121K, the toner bottle 121T can be arranged in a location that is hard to be affected by heat from the fixing unit 15. Therefore, degradation of the special color toner stored in the toner bottle of the special color toner 121T can be prevented. Moreover, the toner bottle 121T can be arranged at a different position from an array of the toner bottle of the process color toner 121C, 121M, 121Y and 121K. Accordingly, when a user changes a toner category of the special color toner, mounting the toner bottle 121T at a wrong position can be prevented.

Surface of the photoconductor drum 122 is uniformly charged by the charging unit 123, and an electrostatic latent image is formed on the surface by the exposure unit 124 based on image information received from the control unit 10. Moreover, the developing unit 125 causes toner to adhere to the surface of the photoconductor drum 122 where the electrostatic latent image is formed, and thereby a toner image is formed. Moreover, the photoconductor drum 122 is arranged so as to contact the intermediate transfer belt 143, and arranged so as to rotate in the same direction as a moving direction of the intermediate transfer belt 143 at a contact point with the intermediate transfer belt 143.

The charging unit 123 uniformly charges the surface of the photoconductor drum 122.

The exposure unit 124 irradiates the surface of the photoconductor drum 122 charged by the charging unit 123 with light based on halftone dot area ratios of the respective colors that are determined by the control unit 10, to form an electrostatic latent image.

The developing unit 125 causes the toners of respective colors stored in the developing agent storage units (toner bottle) 121 to adhere to the electrostatic latent image formed on the surface of the photoconductor drum 122 by the exposure unit 124, to perform developing, and form a toner image.

The discharging unit 126 discharges the surface of the photoconductor drum 122 after the image has been transferred to the intermediate transfer belt 143.

The cleaning unit 127 removes transfer residual toner remaining on the surface of the photoconductor drum 122 that is discharged by the discharging unit 126.

The image forming unit of the special color toner 120T is arranged the most upstream in a conveyance direction of the intermediate transfer belt 143 compared with the image forming units of the process color toners 120C, 120M, 120Y and 120K. Therefore, the special color toner is transferred on an upper layer higher than the process color toner on a printed material, and a printed material of high value can be generated taking advantage of the characteristics of the special color toner.

The paper feed unit 13 is a member that feeds a sheet of paper to the transfer unit 14. The paper feed unit 13 is provided with a paper storage unit 131, a paper feeding roller 132, a paper feeding belt 133, and a registration roller 134 (position adjustment roller).

The paper storage unit 131 stores sheets of paper.

The paper feeding roller 132 is arranged so as to rotate to move a sheet of paper stored in the paper storage unit 131 toward the paper feeding belt 133. The paper feeding roller 132 that is arranged in this way picks up a sheet of paper on the upper most stage of the stored sheets of paper and sends to the paper feeding belt 133.

The paper feeding belt 133 conveys the sheet of paper sent from the paper feeding roller to the transfer unit 14.

The registration roller 134 sends the sheet of paper conveyed by the paper feeding belt 133 at a timing that a part of the intermediate transfer belt 143 where a toner image is formed, which will be described later, reaches the transfer unit 143.

The transfer unit 14 transfers the image formed on the photoconductor drum 122 by the image forming unit 12 to the intermediate transfer belt 143 (primary transfer), and transfers the image transferred to the intermediate transfer belt 143 to a sheet of paper (secondary transfer).

The transfer unit 14 is provided with a driving roller 141, a driven roller 142, the intermediate transfer belt 143, primary transfer rollers 144C, 144M, 144Y, 144K and 144T, a secondary transfer roller 145 and a secondary opposed roller 146.

The intermediate transfer belt 143 is wrapped around the driving roller 141 along with the driven roller 142. The driving roller 141 drives and rotates, and thereby the stretched intermediate transfer belt 143 moves.

The intermediate transfer belt 143 is wrapped around the driven roller 142 along with the driving roller 141. The driven roller 142 rotates when the driving roller 141 rotates and the intermediate transfer belt 143 moves.

The intermediate transfer belt 143 is stretched over the driving roller 141 and the driven roller 142, and moves with rotation of the driving roller 141 while contacting the photoconductor drum 122. The intermediate transfer belt 143 moves while contacting the photoconductor drum 122, and thereby the image formed on the photoconductor drum 122 is transferred onto a surface of the intermediate transfer belt 143.

The primary transfer rollers 144C, 144M, 144Y, 144K and 144T are arranged, across the intermediate transfer belt 143, and opposed to the photoconductor drum 122C, 122M, 122Y, 122K and 122T, respectively, and rotate so as to move the intermediate transfer belt 143.

The secondary transfer roller 145 rotates while clamping the intermediate transfer belt 143 and a sheet of paper between the secondary transfer roller 145 and the secondary opposed roller 146.

The fixing unit 15 fixes the toner transferred onto the sheet of paper by the transfer unit 14. The fixing means welding resin component of toner to a sheet of paper by applying simultaneously heat and pressure to toner. The fixing process is performed for the toner transferred onto the sheet of paper by the transfer unit 14, thereby a state of the toner on the sheet of paper becomes stable.

The fixing unit 15 includes a conveyance belt 151, a fixing belt 152, a fixing roller 153, a fixing belt conveyance roller 154, a fixing opposed roller 155 and a heat generation unit 156.

The transfer belt 151 conveys the sheet of paper, on which toner is transferred by the transfer unit 14, toward the fixing roller 153 and fixing opposed roller 155.

The fixing belt 152 is stretched over the fixing roller 153 and the fixing belt conveyance roller 154, and is moved by rotation of the rollers.

The fixing roller 153 clamps the sheet of paper conveyed by the conveyance belt 151 between the fixing roller 153 and the fixing opposed roller 155 that is opposedly arranged, and applies heat and pressure to the sheet of paper.

The fixing belt 152 is wrapped around the fixing belt conveyance roller 154 along with the fixing roller 153, and the fixing belt 152 is also rotated by rotation of the fixing belt conveyance roller 154. The fixing opposed roller 155 is arranged opposed to the fixing roller 153, and clamps the conveyed sheet of paper between the fixing opposed roller 155 and the fixing roller 153.

The heat generation unit 156 is a member that is arranged inside the fixing roller 153, generates heat, and heats the sheet of paper via the fixing roller 153.

The paper ejection unit 16 is a member that ejects the sheet of paper on which toner is fixed by the fixing unit 15 from the image forming apparatus 1, and includes a paper ejection belt 161, a paper ejection roller 162, a paper ejection port 163 and a paper storage unit 164.

The paper ejection belt 161 conveys the sheet of paper subjected to the fixing process by the fixing unit 15 toward the paper ejection port 163.

The paper ejection roller 162 ejects the sheet of paper conveyed by the paper ejection belt 161 from the paper ejection port 163. The ejected sheet of paper is stored in the paper storage unit 164.

The display/operation unit 17 includes a panel display unit (display means) 171 as a reporting means and an operation unit 172. On the panel display unit 171, a setting value, selected image or the like is displayed. Moreover, the panel display unit 171 is a touch panel or the like for accepting an input from an operator. The operation unit 172 is a member, such as ten keys for accepting terms and conditions related to image formation, a start key for accepting a copy start instruction or the like, that a user operates in order to perform input.

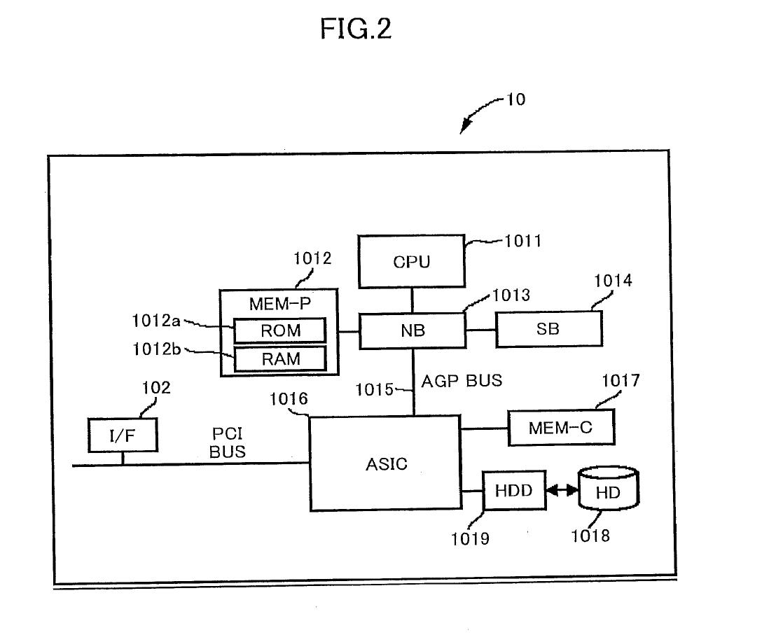

The control unit 10, as illustrated in FIG. 2, includes a CPU (Central Processing Unit) 1011 as a controlling means, a main memory (MEM-P) 1012 as a storage means on the main body side, a north bridge (NB) 1013, a south bridge (SB) 1014, an AGP (Accelerated Graphics Port) bus 1015, an ASIC (Application Specific Integrated Circuit) 1016, a local memory (MEM-C) 1017, an HD (Hard Disk) 1018, an HDD (Hard Disk Drive) 1019 and a network I/F 10.

The CPU 1011, following a program stored in the main memory 1012, processes/calculates data, and controls operations of the image readout unit 11, the image forming unit 12, the paper feeding unit 13, the transfer unit 14, the fixing unit 15, and the paper ejection unit 16.

The main memory 1012 is a memory region for the control unit 10, and includes a ROM (Read Only Memory) 1012a and a RAM (Random Access Memory) 1012b.

The ROM 1012a is a memory for storing programs and data that enable respective functions of the control unit 10. The programs stored in the ROM 1012a may be configured to be recorded in a computer readable recording medium such as a CD-ROM, an FD, a CD-R, or a DVD, as a file in an installable format or an executable format, to be provided.

The RAM 1012b is used as a memory for extending programs or data, for drawing upon memory printing and the like. The NB 1013 is a bridge for connecting the CPU 1011, the MEM-P 1012, the SB 1014, and the AGP bus 1015. The SB 1014 is a bridge for connecting the NB 1013, the PCT device and peripheral devices. The AGP bus 1015 is a bus interface for a graphic accelerator card that has been proposed for speeding up a graphic process.

The ASIC 1016 is configured by a PCI target and an AGP master, an arbiter (ARB) that is a core of the ASIC 1016, a memory controller for controlling the MEM-C 1017, a plurality of DMACs (Direct Memory Access Controllers) for performing rotation of image data according to hardware logic or the like. This ASIC 1016 is coupled to an interface of a USB (Universal Serial Bus) via a PCI bus, or to an interface of IEEE 1394 (Institute of Electrical and Electronics Engineers 1394).

The MEM-C 1017 is a local memory used for an image buffer for copy and a code buffer. The HD 1018 is a storage for performing accumulation of image data, accumulation of font data used on printing, accumulation of forms. The HDD 1019 controls reading out data/writing data from/into the HD 1018 following control of the CPU 1011. The network I/F 102 sends/receives information to/from an external apparatus such as an information processing apparatus via a communication network.

Next, a supply toner conveyance path 180 will be described. In order to describe the supply toner conveyance path 180, a supply toner conveyance path 180T for special color toner will be described. This description can be applied to supply toner conveyance paths for process color toners 180C, 180M, 180Y and 180K.

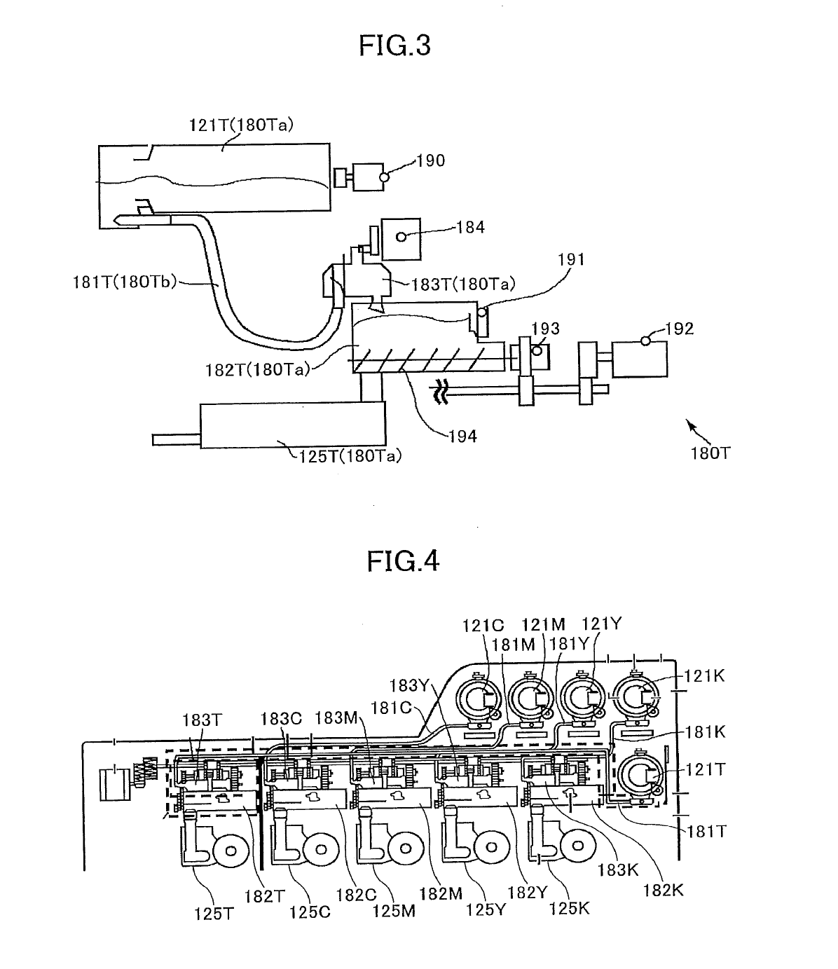

The supply toner conveyance path 180T for special color toner is provided with, as illustrated in FIG. 3, a supply tube 181T coupled to the toner bottle 121T, a diaphragm pump 183T as a conveyance means, a sub hopper 182T as a temporary accumulation unit, a developing unit 125T, and the like. However, the supply toner conveyance path 180T is not limited to this configuration.

In the toner bottle 121T stored in the toner bottle storage unit of the image forming apparatus main body, according to a driving force by a bottle driving motor 190, a conveyance screw in the toner bottle drives. Toner encapsulated inside the toner bottle 121T is conveyed to the sub hopper 182T via the supply tube 181T, based on detection information by a toner end sensor 191 that detects a toner amount in the sub hopper 182T. The diaphragm pump 183T as a conveyance means for conveying toner causes negative pressure to occur by a driving force from the diaphragm pump motor 184.

Toner that is conveyed and accumulated in the sub hopper 182T is stirred by a supply screw 194 that a supply motor 192 drives via a supply clutch 193. The toner conveyed and accumulated in the sub hopper 182T is conveyed appropriately to the developing unit 125T. The case where supply toner is conveyed to the developing unit 125T is, for example, referred to as the case where a toner amount of the developing unit 125T becomes a threshold value or less or the like.

Incidentally, the toner bottle 121T, the developing unit 125T and the like of the supply toner conveyance path 180T have different useful lives, respectively. Therefore, the conventional image forming apparatus, in which the supply toner conveyance path is unitized and whole set of unitized supply toner conveyance path is replaced, requires replacement of whole set of supply toner conveyance path in accordance with a time for replacement for a component having a short useful life. As a result, cost performance has been quite low.

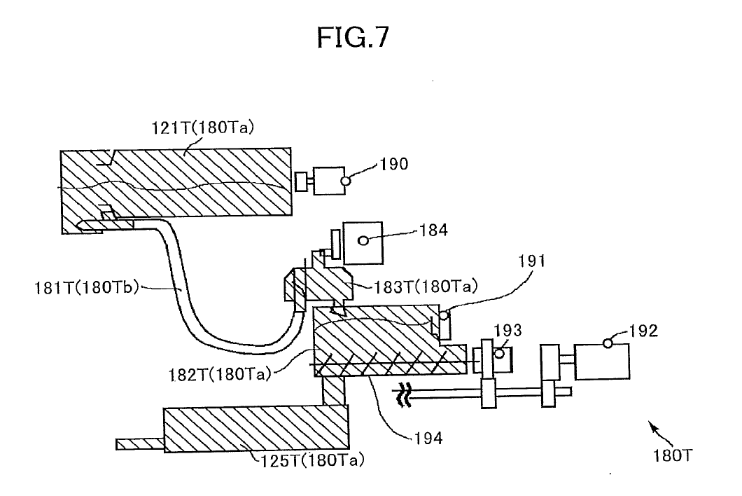

As for the supply toner conveyance path 180T according to the embodiment, the toner bottle 121T is provided so that a user grasps an end part of the toner bottle 121T and pulls it out from the image forming apparatus 1 to remove it and replaces it by a new toner bottle. In the embodiment, the diaphragm pump 183T and the sub hopper 182T that are integrally molded can be removed from the image forming apparatus 1 by removing a screw, and replaced by a new diaphragm pump 183T and a sub hopper 182T. The developing unit 125T can be pulled out along a slide rail to be removed from the image forming apparatus 1, and replaced by a new developing unit 125T. That is, in the embodiment, as described later using FIG. 7, all components of the supply toner conveyance path 180T except for the supply tube 181T can be individually replaced.

The supply toner conveyance path 180T has a high cost performance compared with the conventional supply toner conveyance path, because each component can be replaced individually in accordance with a useful life of the component. In addition, for the sake of convenience of description, among the supply toner conveyance paths 180T, a toner bottle 121T, a diaphragm pump 183T, a sub hopper 182T, a developing unit 125T and the like that require replacement upon replacing by toner of different category will be referred to as a first toner conveyance path 180Ta, and a supply tube 181T that does not require replacement will be referred to as a second toner conveyance path 180Tb.

Incidentally, in the supply toner conveyance path 180T, the supply tube 181T is served as a configuration that is not replaced. Therefore, when the supply toner conveyance path 180T is replaced by a member that corresponds to toner of different category, color mixture may be invited. For example, when the first toner conveyance path 180Ta is replaced from that for clear toner to that for white toner, unless any measures are taken, clear toner in the supply tube 181T and white toner in the replaced toner bottle 121 are mixed.

In order to avoid such a problem, the image forming apparatus 1 of the embodiment executes a cleaning process for the supply tuber 181T by a cleaning means. The cleaning process for the supply tube 181T is performed, for example, in a state where nothing is connected to both ends of the supply tube 181T, by suctioning out from one of the ends by a cleaner as the cleaning means. In this way, toner inside the supply tube 181T can be removed. The cleaning device is not limited to this mode, but may have, for example, a configuration where a fan directed to one end of the supply tube 181T ejects forcibly toner inside the supply tube 181T from other end. Moreover, for the cleaning means, a means that is not provided in the image forming apparatus 1 may be used.

The supply tube 181T is preferably in an upward direction in a state where at least one of the two ends is arranged in the image forming apparatus 1. By making at least one of the two ends of the supply tuber 181T be in an upward direction, upon the cleaning process, toner inside the supply tube 181T can be prevented from falling inside the image forming apparatus from the other of the two ends of the supply tube 181T.

In addition, in the supply toner conveyance path 180T, because the supply tube 181T can be the same as a useful life of the main body of the image forming apparatus or more, the supply tube 181T is not required to be replaced by a new supply tube, but may be replaced by a new supply tube. Moreover, for a direct toner supply method for directly supplying toner from the toner bottle to the developing unit without going through the supply toner conveyance path, the cleaning of the supply toner conveyance path is unnecessary.

Next, an attachment/detachment state detection means that enables detection of attachment/detachment state of the respective components of the first toner conveyance path 180Ta, and a toner category detection means that enables detection of toner category of the respective components of the first toner conveyance path 180Ta will be described.

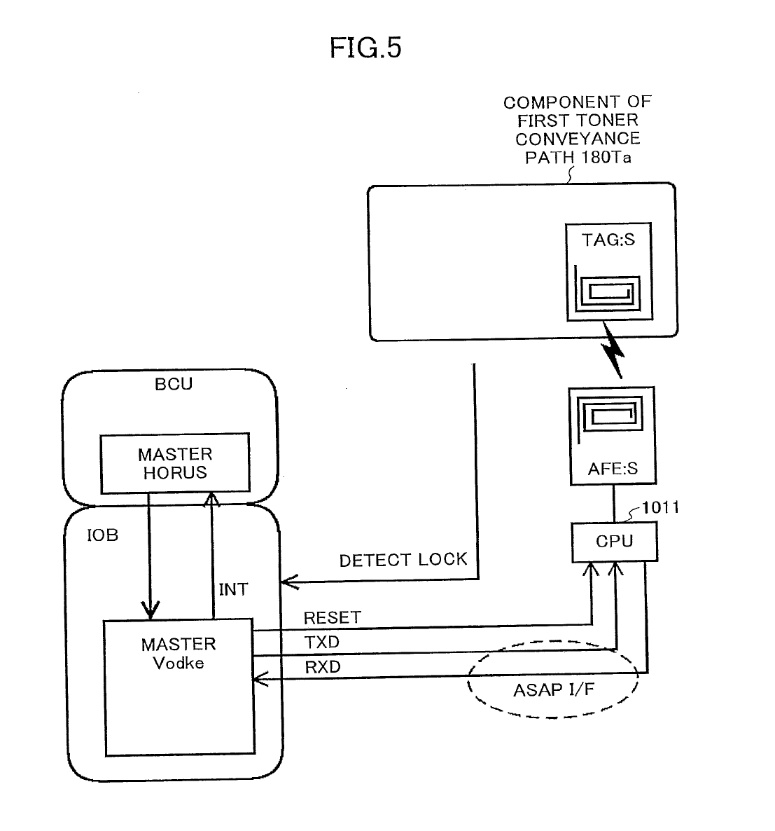

The attachment/detachment state detection means and the toner category detection means include, as illustrated in FIG. 5, include an RFID (Radio Frequency Identification) tag as an information storage medium attached to a component of the first toner conveyance path 180Ta, a substrate provided with an antenna and a modulation/demodulation IC of ich (which will be referred to as an AFE (analog front end) in the following), a substrate provided with a CPU or the like. Data transmission/reception is performed at the ASAP I/F to/from a main body (BCU/IOB).

Specifically, between an M_Vodka (main body) and the CPU (RFID_RW), command data are transmitted/received (serial 9600 bps) at the ASAP_I/F. Then, the CPU (RFID_RW) performs CPU reset by port reset (M_Vodka). Then, an ASAP command analysis and data code conversion (mirror code conversion) are performed by internal process of the CPU (RFID_RW). Then, command/data transmission/reception (serial 106 kbps (13.56 MHz)) is performed between the CPU and an AFE (RFID_RW). Then, ASK demodulation is performed at the AFE (RFID_RW), and Read/Write (carrier wave 13.56 MHz and bit rate 26 kbps) is performed to an RF tag.

Then, the CPU 1011 as a control means determines presence or absence of detection information of the attachment/detachment state detection means, i.e. communication information from the RFID tags attached to the respective components of the first toner conveyance path 180Ta, and detects attachment/detachment states of the respective components of the first toner conveyance path 180Ta.

In addition, the attachment/detachment state detection means performs determination by presence or absence of communication information from the RFID tags, but is not limited to this mode. For example, by the CPU 1011 determining presence or absence of connection between the respective components of the first toner conveyance path 180Ta and a connection connector attached to the main body side of the image forming apparatus, presence or absence of attachment/detachment state of the toner bottle 121T and/or the supply toner conveyance means 180 and/or the developing unit 125T may be determined.

Moreover, the CPU 1011 as a control means determines toner category, based on detection information of the toner category detection means, i.e. communication information from the RFID tags attached to the respective components of the first toner conveyance path 180Ta. In addition, the communication information from the RFID tags attached to the respective components of the first toner conveyance path 180Ta may be stored in the main memory 1012. In this case, from information stored in the main memory 1012, the CPU 1011 can determine toner category of the respective components of the first toner conveyance path 180Ta.

In addition, the toner category detection means is not limited to this mode. For example, protrusions may be formed on the respective components of the first toner conveyance path 180Ta so that a position is different for each toner category, and the position of the protrusion is detected by an optical sensor, in a state where the respective components of the first toner conveyance path 180Ta are attached to the image forming apparatus main body, and thereby the CPU 1011 determines toner category. Moreover, a user may read out by using a detector with a two dimensional code such as QR code (trademark registered) provided on the respective components of the first toner conveyance path 180Ta, and thereby with toner category is recognized.

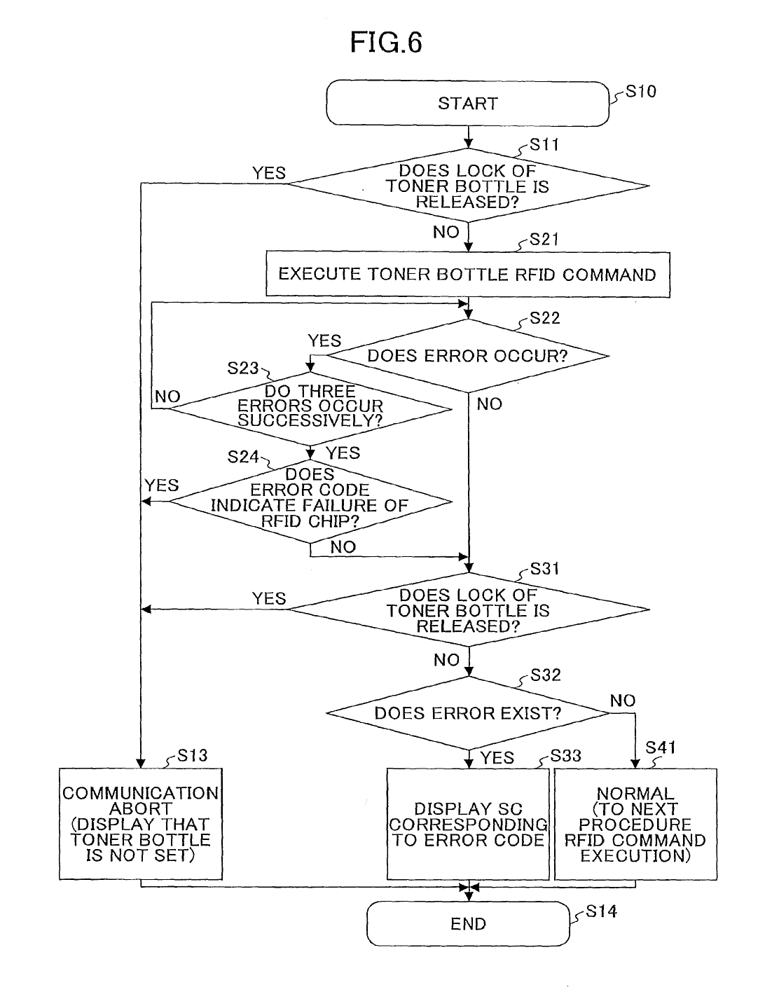

Next, start flows of the RFID tags attached to respective components of the first toner conveyance path 180Ta will be described with reference to FIG. 6. Because the start flows of the RFID tags attached to respective components of the first toner conveyance path 180Ta has the same configuration, description will be provided for the toner bottle 121T, and descriptions for the other components will be omitted.

First, execution of start system for an RFID tag starts, and an RFID communication starts (step S10). Then, a toner bottle lock detection sensor, as the attachment/detachment state detection means, determines whether a lock of the toner bottle 121T is released (step S11). When the toner bottle lock detection sensor determines that the lock of the toner bottle 121T is released, the communication is suspended, the panel display unit 171 displays that a toner bottle is not set (step S13), and the RFID communication ends (step S14).

On the other hand, when the toner bottle lock detection sensor determines that the lock of the toner bottle 121T is not released, a toner bottle RFID commend is executed (step S21). Then, whether there is occurrence of an error is determined (step S22).

When an error is determined to occur, whether there is occurrence of successive three errors is determined (step S23). When successive three errors do not occur, the process returns to step S22. On the other hand, when successive three errors occur, whether a failure of the RFID chip as the error is determined (step S24). When the error is determined to be a failure of the RFID chip, the communication is suspended, the panel display unit 171 displays that a toner bottle is not set (step S13), and the RFID communication ends (step S14).

On the other hand, when the error is determined not to be a failure of the RFID chip, the toner bottle lock detection sensor determines whether the lock of the toner bottle 121T is released (step S31). When the toner bottle lock detection sensor determines that the lock of the toner bottle 121T is released, the communication is suspended, the panel display unit 171 displays that a toner bottle is not set (step S13), and the RFID communication ends (step S14).

On the other hand, when the toner bottle lock detection sensor determines that the lock of the toner bottle 121T is not released, whether there is an occurrence of error is determined (step S32). When an error is determined to occur, the panel display unit 171 displays a serviceman-call (SC) display corresponding to the error that occurs (step S33), and the RFID communication ends (step S14).

On the other hand, when an error is not determined to occur, the panel display unit 171 displays a display indicating normal (step S33), and the RFID communication ends (step S14).

In addition, in step S22, when an error is determined not to occur, the process proceeds to step S31, and a routine in above-described steps S32 through S14 are executed.

Incidentally, when, for the same supply toner conveyance path 180T, toners of different categories are used in the toner bottle 121T, the developing unit 125T or the like, the toners of different categories may be mixed. Then, the entire supply toner conveyance path 180T must be cleaned or replaced. For example, when the toner bottle 121T for clear toner and the developing unit 125T for white toner are used in the same supply toner conveyance path 180T, clear toner and white toner mix in the supply toner conveyance path, the entire supply toner conveyance path T must be cleaned or replaced.

In order to solve such a problem, the image forming apparatus 1 according to the embodiment executes the following controls:

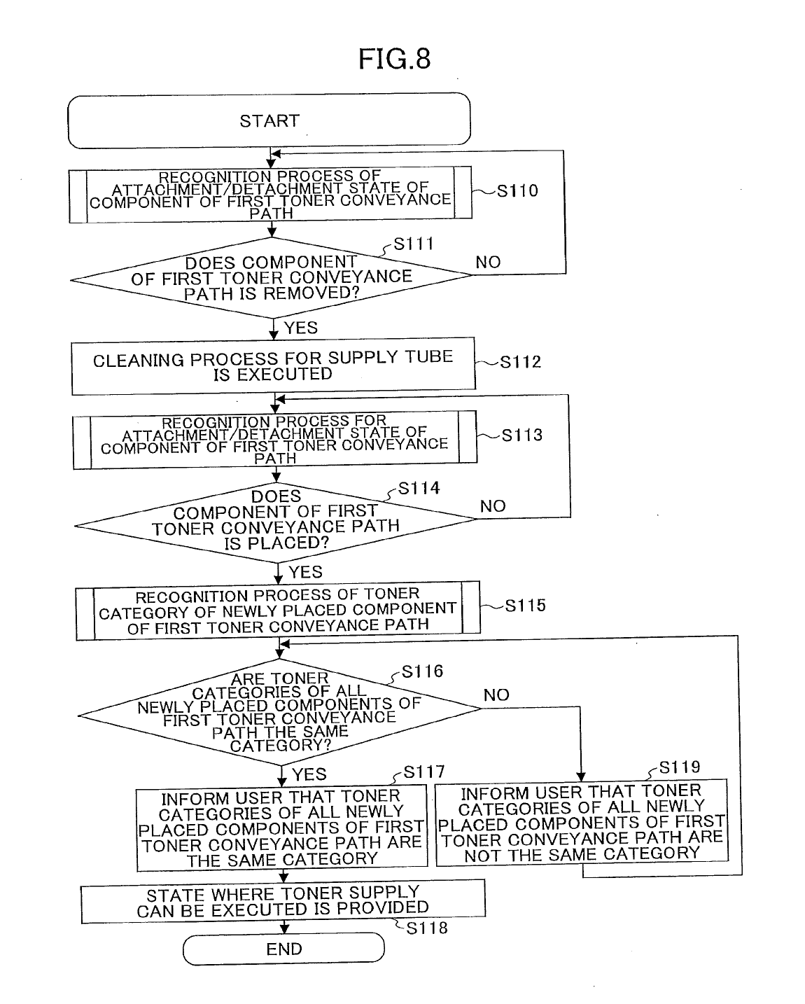

At first, a case of replacing all components of the first toner conveyance path 180Ta illustrated by hatching in FIG. 7 by new components of the first toner conveyance path 180Ta in order to use toner of different toner category will be described with reference to a flowchart illustrated in FIG. 8. The flowchart is merely a description of an example of a routine that an effect of the present invention can be exerted in the embodiment, and needless to say, within a range where the effect of the present invention can be exerted, another flowchart can be applied. Moreover, the case of replacing all components of the first toner conveyance path 180Ta by new components of the first toner conveyance path 180Ta in order to use toner of different toner category is, for example, a case where in a supply toner conveyance path 180T of color “T” the first toner conveyance path 180Ta is replaced from that for clear toner to that for white toner.

At first, the replacement of all components of the first toner conveyance path 180Ta starts, and the process moves to a subroutine of an attachment/detachment state recognition process for the respective components of the first toner conveyance path 180Ta, and execution is performed (step S110).

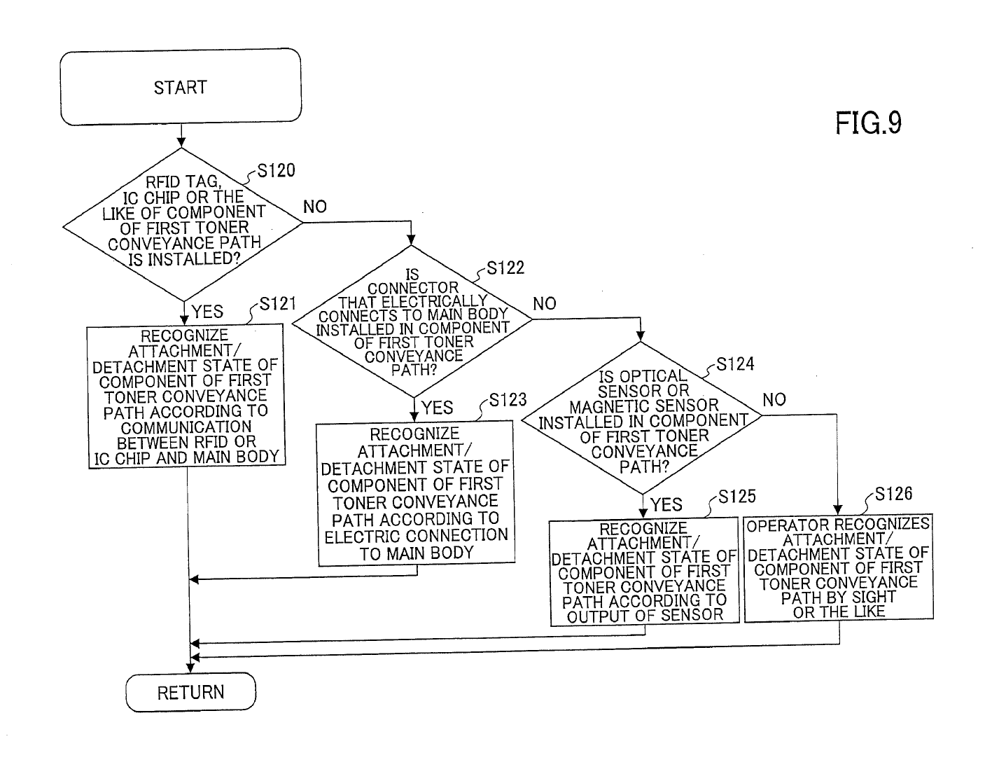

FIG. 9 is a flowchart depicting the subroutine of the attachment/detachment state recognition process for component of the first toner conveyance path 180Ta. At first, the attachment/detachment state recognition process for component of the first toner conveyance path 180Ta starts, and the CPU 1011 determines whether an RFID tag, an IC tag or the like is installed in the component of the first toner conveyance path 180Ta (step S120). When the CPU 1011 determines that an RFID tag, an IC tag or the like is installed in the component of the first toner conveyance path 180Ta, the attachment/detachment state of the component of the first toner conveyance path 180Ta is recognized by a communication between the RFID tag, the IC tag or the like and the image forming apparatus main body (step S121), the subroutine ends, and the process returns to the main flow.

When the CPU 1011 determines that an RFID tag, an IC tag or the like is not installed in a component of the first toner conveyance path 180Ta, the CPU 1011 determines whether a connector that electrically coupled to the image forming apparatus main body is installed in the component of the first toner conveyance path 180Ta (step S122). When the CPU 1011 determines that the connector electrically coupled to the image forming apparatus main body is installed in the component of the first toner conveyance path 180Ta, according to the electric coupling between the image forming apparatus main body and the connector, an attachment/detachment state of the component of the first toner conveyance path 180Ta is recognized (step S123), the subroutine ends, and the process returns to the main flow.

When the CPU 1011 determines that the connector electrically coupled to the image forming apparatus main body is not installed in the component of the first toner conveyance path 180Ta, the CPU 1011 determines whether an optical sensor or a magnetic sensor is installed in the component of the first toner conveyance path 180Ta (step S124). When the CPU 1011 determines that the optical sensor or the magnetic sensor is installed in the component of the first toner conveyance path 180Ta, according to an output from the installed optical sensor or the magnetic sensor, an attachment/detachment state of the component of the first toner conveyance path 180Ta is recognized (step S125), the subroutine ends, and the process returns to the main flow.

When the CPU 1011 determines that the optical sensor or the magnetic sensor is not installed in the component of the first toner conveyance path 180Ta, the panel display unit 171 displays a message to urge to confirm an attachment/detachment state of the component of the first toner conveyance path 108Ta. Then, an operator inputs, via the operation unit 172 or the like, the attachment/detachment state of the component of the first toner conveyance path 180Ta recognized by sight or the like (step S126), thereby the CPU 1011 ends the subroutine, and the process returns to the main flow.

Subsequently, the CPU 1011 or the operator determines whether a component of the first toner conveyance path 180Ta is removed (step S111). When the component of the first toner conveyance path 180Ta is determined not to be removed, the process returns to step S110. On the other hand, when the component of the first toner conveyance path 180Ta is determined to be removed, the process moves to the cleaning process for the supply tube 181T and execution is performed (step S112).

Next, the process moves to the subroutine of recognition process for an attachment/detachment state of a component of the first toner conveyance path 180Ta and execution is performed (step S113).

Subsequently, the CPU 1011 or the operator determines whether a component of the first toner conveyance path 180Ta is mounted (step S114). When the component of the first toner conveyance path 180Ta is determined not to be mounted, the process returned to step S113. On the other hand, when the component of the first toner conveyance path 180Ta is determined to be mounted, the process moves to a subroutine of a toner category recognition process for toner used in the newly mounted component of the first toner conveyance path 180Ta, and execution is performed (step S115).

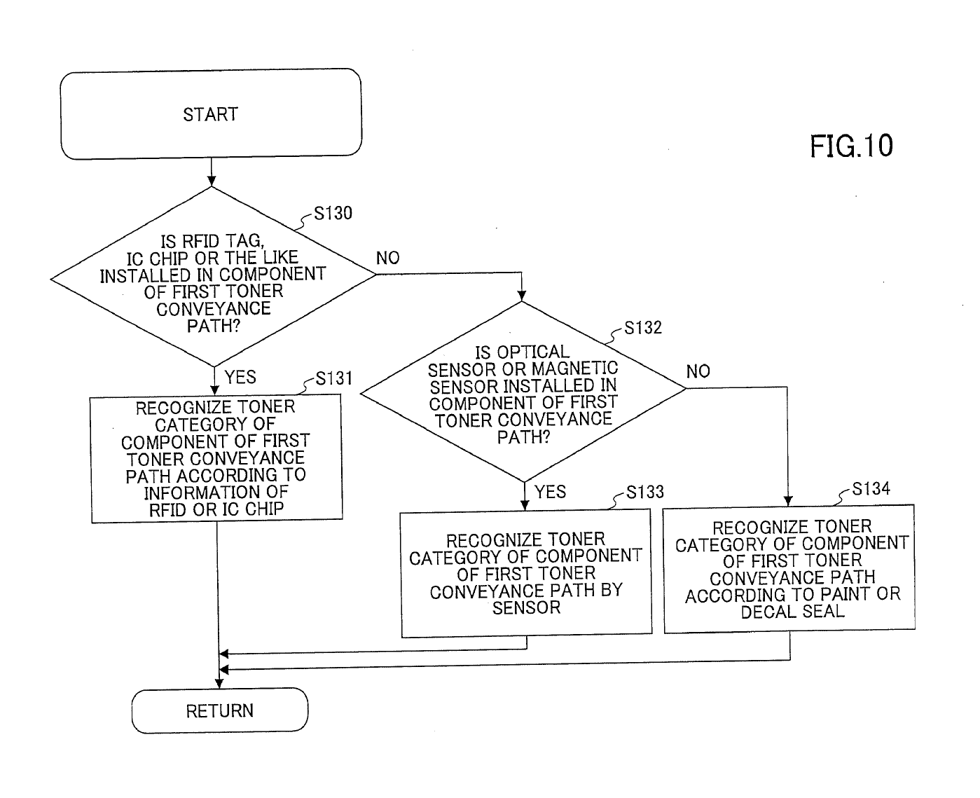

FIG. 10 is a flowchart depicting a subroutine of a toner category recognition process for toner used in a component of the first toner conveyance path 180Ta. At first, the toner category recognition process for toner used in the component of the first toner conveyance path 180Ta starts, and the CPU 1011 determines whether an RFID tag, an IC tag or the like is installed in the component of the first toner conveyance path 180Ta (step S130). When the CPU 1011 determines the RFID tag, the IC tag or the like is installed in the component of the first toner conveyance path 180Ta, based on information from the RFID tag, the IC tag or the like, toner category of toner used in the component of the first toner conveyance path 180Ta is recognized (step S131), the subroutine ends, and the process returns to the main flow.

When the CPU 1011 determines that the RFID tag, the IC tag or the like is not installed in the component of the first toner conveyance path 180Ta, the CPU 1011 determines whether an optical sensor or a magnetic sensor is installed in the component of the first toner conveyance path 180Ta (step S132). When the CPU 1011 determines that the optical sensor or the magnetic sensor is installed in the component of the first toner conveyance path, according to an output from the installed optical sensor or the magnetic sensor, toner category of toner used in the component of the first toner conveyance path 180Ta is recognized (step S1). For example, as described above, a position of protrusion, which is formed so as to be different for each toner category, is detected by the optical sensor, and thereby the CPU 1011 recognizes toner category of toner used in the component of the first toner conveyance path 180Ta. Then, the subroutine ends, and the process returns to the main flow.

When the CPU 1911 determines that the optical sensor or the magnetic sensor is not installed in the component of the first toner conveyance path 180Ta, the panel display unit 171 displays a message to urge to confirm toner category of toner used in the component of the first toner conveyance path 108Ta or the like. Then, an operator inputs, via the operation unit 172 or the like, toner category of toner used in the component of the first toner conveyance path 180Ta recognized by sight of paint, decal sheet or the like on the component of the first toner conveyance path 180Ta (step S134), the CPU 1011 ends the subroutine, and the process returns to the main flow.

Next, the CPU 1011 or the operator determines whether toner categories of toners used in all components of the new first toner conveyance path 180Ta mounted to the image forming apparatus main body (in the embodiment, the toner bottle 121T, the diaphragm pump 183T, the sub hopper 182T, the developing unit 125T or the like) are all the same toner category (step S116).

When toner categories of toners used in all components of the new first toner conveyance path 180Ta that is mounted are all the same toner category, the panel display unit 171 reports the user that toner categories of toners used in all components of the mounted new first toner conveyance path 180Ta are all the same toner category, by displaying a banner display, a window display or the like (step S117). Then, a state where a toner supply from the toner bottle 121T can be executed is provided (step S118), and the operation of replacing all components of the first toner conveyance path 180Ta ends.

In addition, when toner categories of toners used in all components of the new mounted new first toner conveyance path 180Ta are all the same toner category, if the user is not reported that effect, a problem such as a color mixture does not occur. Then, in this case, configuration can be performed in advance so as not to report the user.

On the other hand, when toner categories of toners used in components of the mounted new first toner conveyance path 180Ta are not the same toner category for at least one component, the panel display unit 171 reports the user that toner categories of toners used in components of the mounted new first toner conveyance path 180Ta are not the same toner category for at least one component, by displaying a banner display, a window display or the like (step S119), and the process returns to step S116. The user may be urged to cause toner categories to be matched with each other by displaying on the panel display unit 171 a banner display, a window display or the like indicating which toner category of component is mismatched. Moreover, in the embodiment, annunciation is performed by displaying a banner display, a window display or the like on the panel display unit 171 as a reporting means, but is not limited to this mode. For example, a lamp may blink or may be lighted, or an alarm buzzer may be sounded.

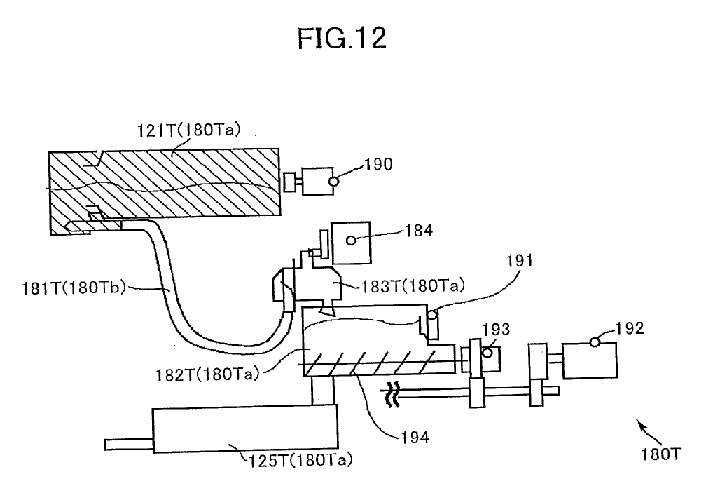

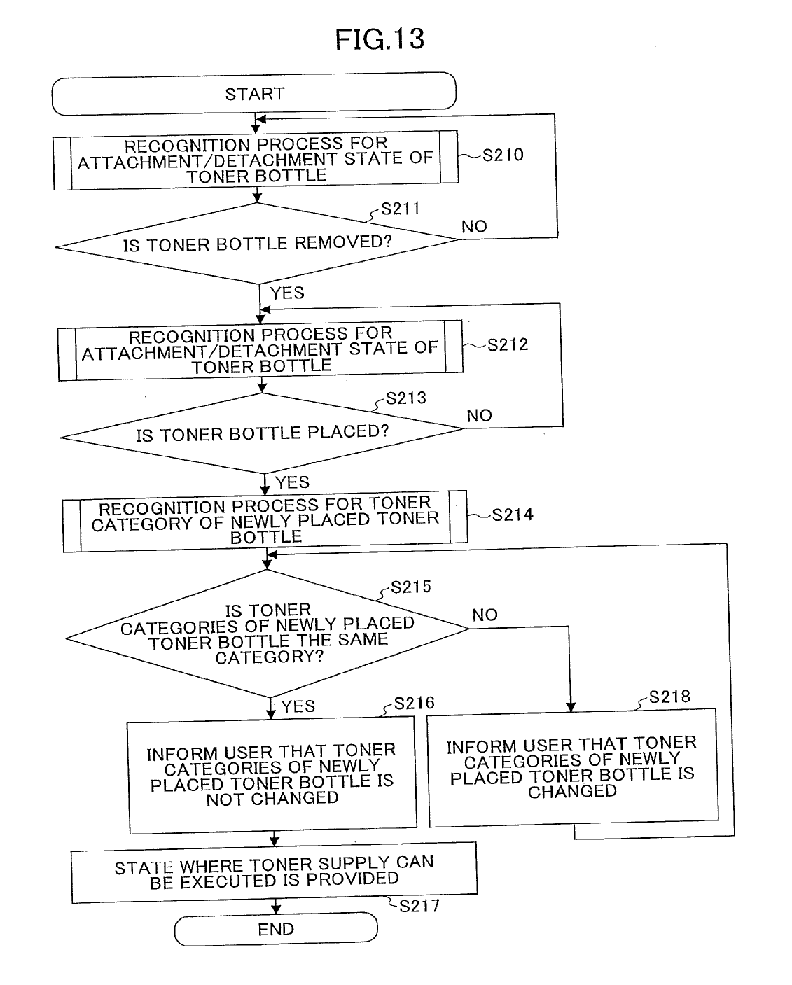

Next, a case of replacing a part of component of the first toner conveyance path 180Ta by a new one will be described with reference to the flowchart depicted in FIG. 13. The flowchart is merely a description of an example of a routine that an effect of the present invention can be exerted in the embodiment, and needless to say, within a range where the effect of the present invention can be exerted, other flowchart can be applied. Moreover, the case of replacing a part of component of the first toner conveyance path 180Ta by a new one is a case where a part of the first toner conveyance path 180Ta reaches a life limit, and the part is replaced. In the following, a case where, among the components of the first toner conveyance path 180Ta, a tonner bottle 121T is replaced by a new one will be described as illustrated in FIG. 12. However, for the other components of the first toner conveyance path 180Ta, the process is the same.

At first, replacement of the tonner bottle 121T starts, and the process moves to a subroutine of a recognition process for attachment/detachment of the toner bottle 121T, i.e. an attachment/detachment state recognition process for a component of the first toner conveyance path 180Ta, and execution is performed (step S210).

Next, the CPU 1011 or the operator determines whether the toner bottle 121T is removed (step S211). When the toner bottle 121T is determined not to be removed, the process returns to step S210. On the other hand, when the toner bottle 121T is determined to be removed, the process moves to the subroutine of the recognition process for attachment/detachment of the toner bottle 121T, i.e. the attachment/detachment state recognition process for a component of the first toner conveyance path 180Ta, and execution is performed (step S212).

Next, the CPU 1011 or the operator determines whether the toner bottle 121T is mounted (step S213). When the toner bottle 121T is determined not to be mounted, the process returns to step S112. On the other hand, when the toner bottle 121T is determined to be mounted, the process moves to a subroutine of a recognition process for toner category for a mounted new toner bottle 121T, i.e. a toner category recognition process for toner used in components of the first toner conveyance path 180Ta, and execution is performed (step S214).

Next, the CPU 1011 or the operator determines whether the toner stored in the new toner bottle 121T mounted on the image forming apparatus main body and the toner stored in the toner bottle 121T removed from the image forming apparatus main body are the same toner category, i.e. whether toner categories are the same toner category before and after the replacement of the toner bottle 121T, from information stored in the main memory 1012 (step S215).

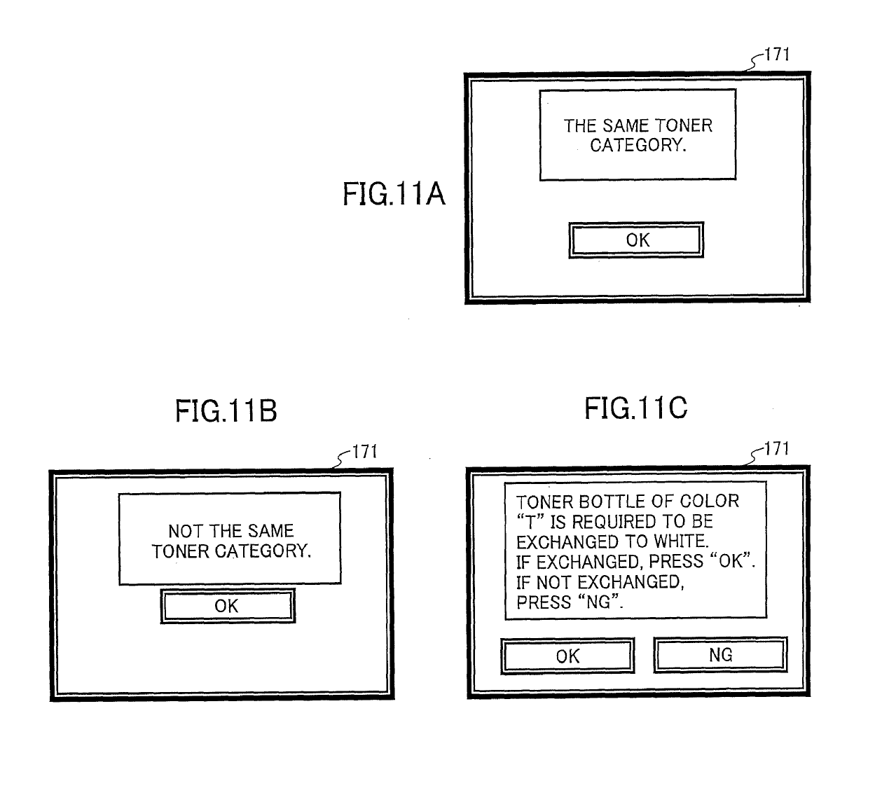

When the toner categories are the same toner category before and after the replacement of the toner bottle 121T, the panel display unit 171 displays a banner display, a window display or the like indicating that the toner categories are the same toner category, as illustrated in FIG. 11A, and thereby the user is reported (step S216). Then, a state where toner supply from the toner bottle 121T can be executed is provided (step S217), and the replacement operation for the toner bottle 121T as a part of component of the first toner conveyance path 180Ta ends.

On the other hand, when the toner categories are not the same toner category before and after the replacement of the toner bottle 121T, the panel display unit 171 displays a banner display, a window display or the like indicating that the toner categories are not the same toner category, as illustrated in FIG. 11B, thereby the user is reported (step S118), and the process returns to step S115. In addition, instead of the display illustrated in FIG. 11B, a banner display, a window display or the like urging to cause toner categories to be matched with each other may be displayed on the panel display unit 171, as illustrated in FIG. 11C, for example, “Toner bottle for color T needs to be replaced by for white. If replaced, press OK. If not replaced, press NG”.

In addition, when only the toner bottle 121T is replaced, because the toner bottle 121T is replaced by a new toner bottle 121T including toner category that is the same toner category and also for the other components of the first toner conveyance path 180Ta the same toner category is used, execution of cleaning process of the supply tube 181T is unnecessary.

Incidentally, in a case of avoiding using toners of different toner categories in a toner bottle, a developing unit and the like for the same supply toner conveyance path by a configuration of replacing for each image forming station, because the image forming station is replaced in a state where a printing operation of the image forming apparatus is suspended, there is a problem that printing efficiency is reduced. On the other hand, because according to the image forming apparatus 1 of the embodiment, by executing the above-described control, using toners of different toner categories in a toner bottle, a developing unit and the like for the same supply toner conveyance path is avoided, the toner bottle 121T can be configured so as to be replaced individually, and the toner bottle 121T can be replaced even during a printing operation. Therefore, compared with the configuration of replacing for each image forming station, the printing efficiency can be enhanced.

In the embodiment, the supply toner conveyance path 180T of the special color toner is described. However, the description may be applied to the supply toner conveyance paths 180C, 180M, 180Y or 180K of process toners.

Next, an action of the image forming apparatus according to the embodiment will be described. Because the image forming apparatus 1 according to the embodiment has the toner category detection means, upon replacing the supply toner conveyance path 180T by that of different toner category, the image forming apparatus 1 can detect whether toner categories of toners used in all components of the first supply toner conveyance path iSOTa are the same toner category, color mixture of different category toner can be prevented. Moreover, because the first toner conveyance path 180Ta can replace the components thereof individually, and compared with the conventional image forming apparatus that performs replacement for each image forming station, a frame of high rigidity is not necessary, the image forming apparatus can be downsized and handleability and replacing activity can be enhanced.

Moreover, the first toner conveyance path 180Ta has a high cost performance compared with the conventional supply toner conveyance path, because each component can be replaced individually in accordance with a useful life of the component. Moreover, because the first toner conveyance path 180Ta includes a cleaning means for cleaning the supply tube 181T, the supply tube 181T can be used without replacing as long as the useful life remains.

Moreover, because the supply toner conveyance path 180T includes a diaphragm pump 183, a position of the toner bottle 121T can be arranged irrelevantly to a position of the developing unit 125T, and thereby a degree of freedom of design can be increased. Moreover, because at least one of two ends of the supply tube 181T is arranged in an upward direction, when the supply tube 181T is cleaned by the cleaning means, toner inside the supply tube 181T can be prevented from falling in the image forming apparatus from other end of the two ends of the supply tube 181T.

In the embodiment, the configuration where the supply toner conveyance path includes the supply tube 181, the diaphragm pump 183, the sub hopper 182, and the developing unit 125 is described. But, the embodiment is not limited to this mode. Moreover, the above-described flowchart is merely a description of an example of a routine that an effect of the present invention can be exerted in the embodiment, and needless to say, within a range where the effect of the present invention can be exerted, other flowchart can be applied.

According to the invention, an image forming apparatus, in which toner can be easily replaced by different toner, in which waste of toner is suppressed and color mixture of toner can be prevented, can be provided.

Although the exemplary embodiments of the present invention are described, the present invention is not limited to any of the embodiments. Materials or sizes introduced in the embodiments are merely an example, and needless to say, within a range where the effect of the present invention can be exerted, various materials and sizes may be selected.

The present invention also includes aspects described as follows. (Aspect A) In an image forming apparatus comprising a plurality of developing means 125 configured to use toners of toner categories different from each other; a plurality of toner containers 121 configured to store the toners of the toner categories different from each other; and a plurality of connection means 181 configured to connect the respective plurality of toner containers 121 with a corresponding one of the plurality of developing means 125, respectively, and provided with a supply toner conveyance path 180 for each toner category, including at least as components one of the plurality of developing means 125, one of the plurality of toner containers 121 corresponding to the one of the developing means 125, and one of the plurality of connection means 181 corresponding to the one of the plurality of developing means 125 and to the one of the plurality of toner containers 121,

each of the components of the supply toner conveyance path 180 can be replaced individually, and includes a toner category detection means configured to detect toner category used in each component; a reporting means configured to report whether toner categories used respectively in all components of the same supply toner conveyance path 180 are the same; and a control means 1011 configured to control the reporting means, based on detection information by the toner category detection means, when the component of the supply toner conveyance path 180 is replaced.

(Aspect B)

In the image forming apparatus as described in the aspect A,

the reporting means includes a display means 171 that is viewable.

(Aspect C)

In the image forming apparatus as described in the aspect B,

the control means 1011 controls the reporting means, when toner categories of toners used in the components of the supply toner conveyance path 180 are not the same toner category regarding at least one component, so as to cause the display means 171 to display that the toner categories are not the same toner category.

(Aspect D)

In the image forming apparatus as described in the aspect C,

the display by the display means 171 is display for urging to cause toner categories to be matched with each other.

(Aspect E)

In the image forming apparatus as described in the aspect D,

the display is display indicating toner category of which component is mismatched.

In the image forming apparatus as described in any of the aspects B, C, D and E,

the control means 1011 controls the reporting means, when toner categories of toners used in a component are not the same before and after replacing the component of the supply toner conveyance path 180, so as to cause the display means 171 to display.

(Aspect G)

In the image forming apparatus as described in any of the aspects A, B, C, D, E and F,

the supply toner conveyance path 180 further comprising, as a component, a conveyance means 183 configured to convey toner through the connection means 181 from the toner container 121 to the developing means 125.

(Aspect H)

In the image forming apparatus as described in any of the aspects A, B, C, D, E, F and G,

the supply toner conveyance path 180 further comprising, as a component, a temporary accumulation unit configured to temporarily accumulate toner to be supplied from the toner container 121 to the developing means 125.

(Aspect I)

In the image forming apparatus as described in any of the aspects A, B, C, D, E, F, G and H,

the component of the supply toner conveyance path 180 includes an information storage medium storing information on toner category to be used, and the toner category detection means detects information on toner category to be used in the component of the supply toner conveyance path 180 based on communication information with the information storage medium.

(Aspect J)

In the image forming apparatus as described in the aspect I,

a main body side storage means 1012 configured to store detection information by the toner category detection means is further provided, and

the control means 1011 controls the reporting means based on storage information of the main body side storage means 1012.

(Aspect K)

In the image forming apparatus as described in any of the aspects A, B, C, D, E, F, G, H, I, and J,

an attachment/detachment state detection means configured to detect an attachment/detachment state of the component of the supply toner conveyance path 180 is further provided.

(Aspect L)

In the image forming apparatus as described in the aspect K,

the component of the supply toner conveyance path 180 includes an information storage medium, and the attachment/detachment state detection means detects an attachment/detachment state of the component of the supply toner conveyance path 180 based on communication information with the information storage medium.

(Aspect M)

In the image forming apparatus as described in the aspect K,

the supply toner conveyance path 180 includes a connector configured to electrically connect the component of the supply toner conveyance path 180 with the image forming apparatus main body, and the attachment/detachment state detection means detects an attachment/detachment state of the component of the supply toner conveyance path 180 based on information on presence or absence of connection of the connector.

(Aspect N)

In the image forming apparatus as described in any of the aspects A, B, C, D, E, F, G, and H,

the toner category detection means detects information on toner category to be used in the component of the supply toner conveyance path 180, based on output from a sensor installed in the component of the supply toner conveyance path 180.

(Aspect O)

In the image forming apparatus as described in the aspect N,

an attachment/detachment state detection means configured to detect an attachment/detachment state of the component of the supply toner conveyance path 180 is further provided.

(Aspect P)

In the image forming apparatus as described in the aspect O,

the attachment/detachment state detection means detects an attachment/detachment state of the component of the supply toner conveyance path 180 based on output of the sensor.

(Aspect Q)

In the image forming apparatus as described in any of the aspects A, B, C, D, E, F, G, H, I, J, K, L, M, N, O and P,

a cleaning means configure to clean the connection means 181 is provided,

when a component of the supply toner conveyance path 180 is replaced, the connection means 181 is not replaced but is cleaned by the cleaning means.

(Aspect R)

In the image forming apparatus as described in the aspect Q,

at least one of two ends of the connection means 181 is in an upward direction in a state of being arranged in the image forming apparatus.

(Aspect S)

An attachment/detachment state detection method for detecting an attachment/detachment state of a component of a supply toner conveyance path 180 used in an image forming apparatus, and in the attachment/detachment state detection method for detecting an attachment/detachment state of a supply toner conveyance path 180 provided with, at least as components, a toner container 121 for storing toner, a developing means 125 for using the toner stored in the toner container 121, and a connection means for connecting the toner container 121 with the developing means 125, a control means 1011 detects, when an information storage medium is installed in the component of the supply toner conveyance path 180, an attachment/detachment state of the component of the supply toner conveyance path 180, based on communication information with the information storage medium.

(Aspect T)

In the attachment/detachment state detection method as described in the aspect S,

the control means 1011 detects, when the information storage medium is not installed in the component of the supply toner conveyance path 180 but a connector is installed in the component of the supply toner conveyance path 180, the attachment/detachment state of the component of the supply toner conveyance path 180, based on information on presence or absence of connection of the connector.

(Aspect U)

In the attachment/detachment state detection method as described in the aspect T, the control means 1011 detects, when the information storage medium is not installed in the component of the supply toner conveyance path 180 but a sensor is installed in the component of the supply toner conveyance path 180, the attachment/detachment state of the component of the supply toner conveyance path 180, based on output by the sensor.

(Aspect V)

In the attachment/detachment state detection method as described in the aspect U, when the sensor is not installed in the component of the supply toner conveyance path 180, an operator recognizes the attachment/detachment state of the component of the supply toner conveyance path 180 and instructs the image forming apparatus, and thereby the control means 1011 detects the attachment/detachment state of the component of the supply toner conveyance path 180.

(Aspect W)

A toner category detection method for detecting toner category of a component of a supply toner conveyance path 180 used in an image forming apparatus, and in the toner category detection method for detecting toner category of the supply toner conveyance path 180 provided with, at least as components, a plurality of developing means 125 using toners, toner categories of which are different from each other, a plurality of toner containers 121 for storing toners, toner categories of which are different from each other, and a plurality of connection means 181 configured to connect the respective plurality of toner containers 121 with a corresponding one of the plurality of developing means 125, respectively, a control means 1011 detects, when an information storage medium is installed in the component of the supply toner conveyance path 180, toner category of toner used in the component of the supply toner conveyance path 180, based on communication information with the information storage medium.

(Aspect X)

In the toner category detection method as described in the aspect W, the control means 1011 detects, when the information storage medium is not installed in the component of the supply toner conveyance path 180 but a sensor is installed in the component of the supply toner conveyance path 180, toner category of toner used in the component of the supply toner conveyance path 180, based on output of the sensor.

(Aspect Y)

In the toner category detection method as described in the aspect X,

when the sensor is not installed in the component of the supply toner conveyance path 180,

an operator recognizes an attachment/detachment state of the component of the supply toner conveyance path 180, and instructs the image forming apparatus, and thereby the control means 1011 detects toner category of toner used in the component of the supply toner conveyance path 180.

### REFERENCE SIGNS LIST

121 toner bottle (example of toner container)
122 photoconductor drum (example of image bearer)
125 developing unit (example of developing means)
171 panel display unit (example of reporting means)
180 supply toner conveyance path
181 supply tube (example of connection means)
1011 CPU (example of control means)
1012 main memory (example of main body side storage means)

What is claimed is:

1. An image forming apparatus, comprising:
a plurality of developing units configured to use toners, toner categories of which are different from each other;
a plurality of toner containers configured to store toners, toner categories of which are different from each other;
a plurality of connection units configured to connect the respective plurality of toner containers with a corresponding one of the plurality of developing units, respectively, and
a supply toner conveyance path provided with for each toner category at least as components, one of the plurality of developing units, one of the plurality of toner containers corresponding to the one of the plurality of developing units, and one of the plurality of connection units corresponding to the one of the plurality of developing units and the one of the plurality of toner containers,
wherein each of the components of the supply toner conveyance path can be replaced individually, including a toner category detection unit configured to detect toner category used in each component; a reporting unit configured to report whether toner categories used respectively in all components of the same supply toner conveyance path are the same; and a control unit configured to control the reporting unit, based on detection information by the toner category detection unit, when the component of the supply toner conveyance path is replaced.

2. The image forming apparatus according to claim 1,
wherein the reporting unit includes a display unit that is viewable.

3. The image forming apparatus according to claim 2,
wherein the control unit is configured to control the reporting unit, when toner categories of toners used in the components of the supply toner conveyance path are not the same toner category regarding at least one component, so as to cause the display unit to display that the toner categories are not the same toner category.

4. The image forming apparatus according to claim 2,
wherein the control unit is configured to control the reporting unit, when toner categories of toners used in a component of the supply toner conveyance path before and after replacing the component are not the same, so as to cause the display unit to display.

5. The image forming apparatus according to claim 4,
wherein display by the display unit is display for urging to cause toner categories to be matched with each other.

6. The image forming apparatus according to claim 1,
wherein the supply toner conveyance path further includes, as a component, a conveyance unit configured to convey toner through the connection unit from the toner container to the developing unit.

7. The image forming apparatus according to claim 1,
wherein the supply toner conveyance path further includes, as a component, a temporary accumulation unit configured to temporarily accumulate toner to be supplied from the toner container to the developing unit.

8. The image forming apparatus according to claim 1,
wherein a component of the supply toner conveyance path includes an information storage medium configured to store information on toner category to be used, and
the toner category detection unit is configured to detect information on the toner category to be used in the component of the supply toner conveyance path based on communication information with the information storage medium.

9. The image forming apparatus according to claim 8, further comprising a main body side storage unit configured to store detection information detected by the toner category detection unit,
wherein the control unit is configured to control the reporting unit based on storage information in the main body side storage unit.

10. The image forming apparatus according to claim 8, further comprising an attachment/detachment state detection unit configured to detect an attachment/detachment state of a component of the supply toner conveyance path.

11. The image forming apparatus according to claim 10,
wherein the attachment/detachment state detection unit is configured to detect the attachment/detachment state of the component of the supply toner conveyance path based on communication information with the information storage medium.

12. The image forming apparatus according to claim 10,
wherein the supply toner conveyance path includes a connector configured to electrically connect a component of the supply toner conveyance path with an image forming apparatus main body, and
the attachment/detachment state detection unit is configured to detect the attachment/detachment state of the component of the supply toner conveyance path based on information on presence or absence of connection of the connector.

13. The image forming apparatus according to claim 10, further comprising a cleaning unit configured to clean the connection unit,
wherein when a component the supply toner conveyance path is replaced, the connection unit is not replaced but is configured to be cleaned by the cleaning unit.

14. The image forming apparatus according to claim 13,
wherein at least one of two ends of the connection unit is in an upward direction in a state of being arranged in the image forming apparatus.

15. The image forming apparatus according to claim 1,
wherein the toner category detection unit is configured to detect information on toner category to be used in a component of the supply toner conveyance path based on output from a sensor installed in the component of the supply toner conveyance path.

16. The image forming apparatus according to claim 15, further comprising an attachment/detachment state detection unit configured to detect an attachment/detachment state of a component of the supply toner conveyance path.

17. The image forming apparatus according to claim 16,
wherein the attachment/detachment state detection unit is configured to detect the attachment/detachment state of the component of the supply toner conveyance path based on output from the sensor.

18. The image forming apparatus according to claim 16, further comprising a cleaning unit configured to clean the connection unit,
wherein when a component of the supply toner conveyance path is replaced, the connection unit is not replaced but is configured to be cleaned by the cleaning unit.

19. The image forming apparatus according to claim 18,
wherein at least one of two ends of the connection unit is in an upward direction in a state of being arranged in the image forming apparatus.
